(19) United States
(12) Patent Application Publication
(10) Pub. No.: US 2012/0264580 A1
(43) Pub. Date: Oct. 18, 2012

(54) FORMING DEVICE FOR THE COLD-FORMING OF POCKETS FOR MEDICAL OR PHARMACEUTICAL PRODUCTS IN A SHEET

(75) Inventor: Ulrich Engelhardt, Laupheim (DE)

(73) Assignee: UHLMANN PAC-SYSTEME GMBH & CO. KG, Laupheim (DE)

(21) Appl. No.: 13/444,529

(22) Filed: Apr. 11, 2012

(30) Foreign Application Priority Data
Apr. 15, 2011 (EP) EP 11162581.0

(51) Int. Cl. B31B 1/00

(52) U.S. Cl. 493/52

(57) ABSTRACT

The forming device for the cold-forming of pockets for medical or pharmaceutical products in a sheet serves to form pockets of the smallest possible dimensions so that the products can be positioned stably in their assigned pockets. The forming device has a stamp and a counter-stamp showing a special structure having several rounded or beveled elements.

### RELATED APPLICATIONS

The present patent document claims the benefit of priority to European Patent Application No. EP 11162581.0, filed Apr. 15, 2011, and entitled “FORMING DEVICE FOR THE COLD-FORMING OF POCKETS FOR MEDICAL OR PHARMACEUTICAL PRODUCTS IN A SHEET” the entire contents of each of which are incorporated herein by reference.

### BACKGROUND OF THE INVENTION

The present invention relates to a forming device for the cold-forming of pockets for medical or pharmaceutical products in a sheet.

Blister packs are often used in the production of packaging for medical or pharmaceutical products. In the production of these blister packs, pockets for the medical or pharmaceutical products are formed in a forming sheet; the products are placed in these pockets; and the pockets are then sealed with a cover sheet. Plastics are usually used as the material for the forming sheet, into which the pockets can be formed by thermoforming. The cover sheet usually consists of aluminum or an aluminum laminate.

For certain applications, however, it is necessary to produce the forming sheet out of a special material such as aluminum or an aluminum laminate to guarantee absolute leak-tightness with respect to light or water vapor, for example. Because it is not possible to introduce appropriate pockets into such sheets by thermoforming, difficulties result from the necessity to produce the pockets in the sheet by cold-forming. That is, the cold-forming process is not able to provide pockets with the same small dimensions as a comparable thermoforming process. This leads to several problems. For example, an individual medical or pharmaceutical product cannot be held stably in position in the pocket before it is sealed, which means that, for example, a camera or some other device for detecting broken products in the pockets cannot provide sufficiently accurate results. There is also the danger that the product in question can become stuck between the forming sheet and the cover sheet during the sealing step. Further, removing the product by pressing it out of the larger pocket can be a challenging task.

### BRIEF SUMMARY

It is an object of the present invention to provide a forming device for the cold-forming of pockets for medical or pharmaceutical products in a sheet, by means of which the products can be positioned stably in their assigned pockets and pockets of the smallest possible dimensions can be produced.

According to an aspect of the invention, the forming device for the cold-forming of pockets for medical or pharmaceutical products in a sheet comprises a hold-down and a die plate, at least one of which can be moved relative to the other to clamp the sheet between the hold-down and the die plate in an area around a stretching zone of the forming device. The forming device also comprises at least one stamp and at least one counter-stamp, which are arranged in the stretching zone and serve to form at least one pocket in the firmly clamped sheet, wherein at least one of the two stamps, i.e., either the stamp or the counter-stamp, can be moved relative to the other into a closed forming position of the forming device. The stamp comprises a base body with a working surface, wherein at least one projection extending toward the counter-stamp is arranged on the working surface substantially in the center of the stretching zone; wherein the base body comprises a rounded or beveled edge area on the edges of the working surface; and wherein, when the forming device is in the closed forming position, the sheet rests both against the rounded or beveled edge area of the working surface of the stamp and against the projection of the stamp. In addition, the counter-stamp comprises at least one recess surrounded by webs, in which the at least one projection of the stamp fits when the forming device is in its closed forming position, as a result of which, when the forming device is in its closed forming position, the webs of the counter-stamp rest against the sheet in an intermediate area between the rounded or beveled edge area of the working surface of the stamp and the projection of the stamp. Further, the edge area at the edges of the working surface of the base body of the stamp is rounded or beveled, the projection is rounded or beveled at its edges, and the webs around the recess are rounded or beveled toward the inside.

In this way, a package with graduated pockets is formed, which makes it possible for the products to be held more effectively, provides greater dimensional stability, and ensures that the products are positioned accurately in the pockets. The overall dimensions of the packaging unit, furthermore, can be reduced.

The rounded or beveled edge area of the working surface of the stamp preferably comprises several steps. As a result, the cold-forming process can be adapted individually to the boundary conditions of the cold-forming process present at the time in question.

To improve the uniformity with which the material is formed even more, the projection can also comprise several steps on its edges.

Finally, it is also conceivable that the webs around the recess could comprise several inward-facing steps.

In one embodiment, both the stamp and the counter-stamp can be moved relative to each other. In this case, the stamp can first be moved into a prestretching position to prestretch the material of the sheet and to draw a section of the sheet taut between the projection and the rounded or beveled edge area of the working surface of the stamp. Then the counter-stamp is moved toward the stamp to assume the closed forming position of the forming device, as a result of which the section of the film tautly drawn in the previous step undergoes further forming.

### BRIEF DESCRIPTION OF THE DRAWINGS

Additional features and advantages of the present invention can be derived from the following description, which makes reference to the figures.

FIG. 1 is a cross-sectional view of the course of the process of cold- forming a pocket in a sheet by means of a first embodiment of the forming device according to the invention;

FIG. 2 shows two cross-sectional views of the course of the process of cold-forming a pocket in a sheet by means of a second embodiment of the forming device according to the invention;

FIG. 3 shows two cross-sectional views of the course of the process of cold-forming a pocket in a sheet by means of a third embodiment of the forming device according to the invention;

FIG. 4 shows two cross-sectional views of the course of the process of cold-forming a pocket in a sheet by means of a fourth embodiment of the forming device according to the invention;

FIG. 5 shows two cross-sectional views of the course of the process of cold-forming a pocket in a sheet by means of a fifth embodiment of the forming device according to the invention;

FIG. 6 is a cross-sectional view of the course of the process of cold- forming a pocket in a sheet by means of a sixth embodiment of the forming device according to the invention; and

FIG. 7 is a cross-sectional view of the course of the process of cold- forming a pocket in a sheet by means of a seventh embodiment of the forming device according to the invention.

### DETAILED DESCRIPTION OF SPECIFIC EMBODIMENTS

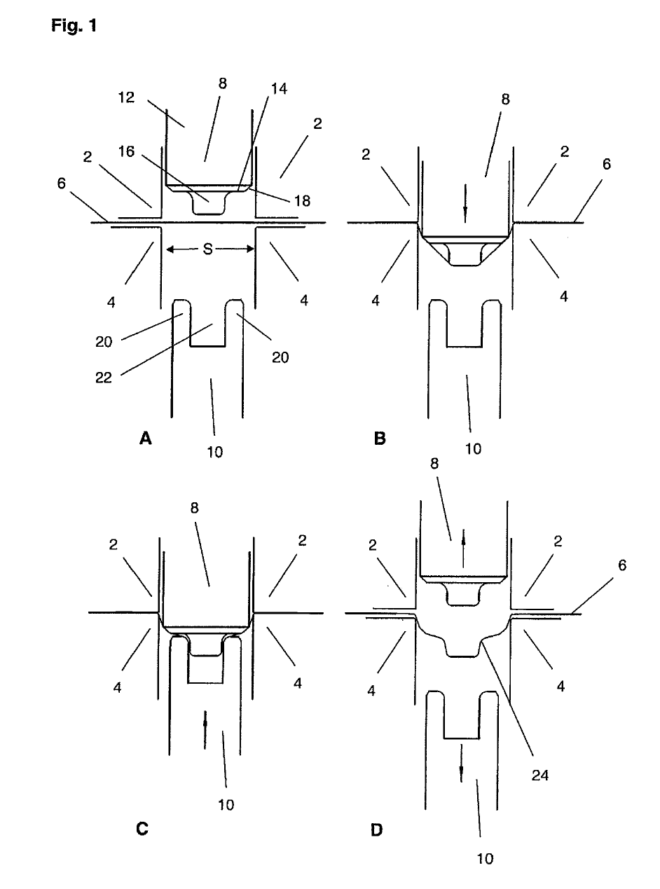

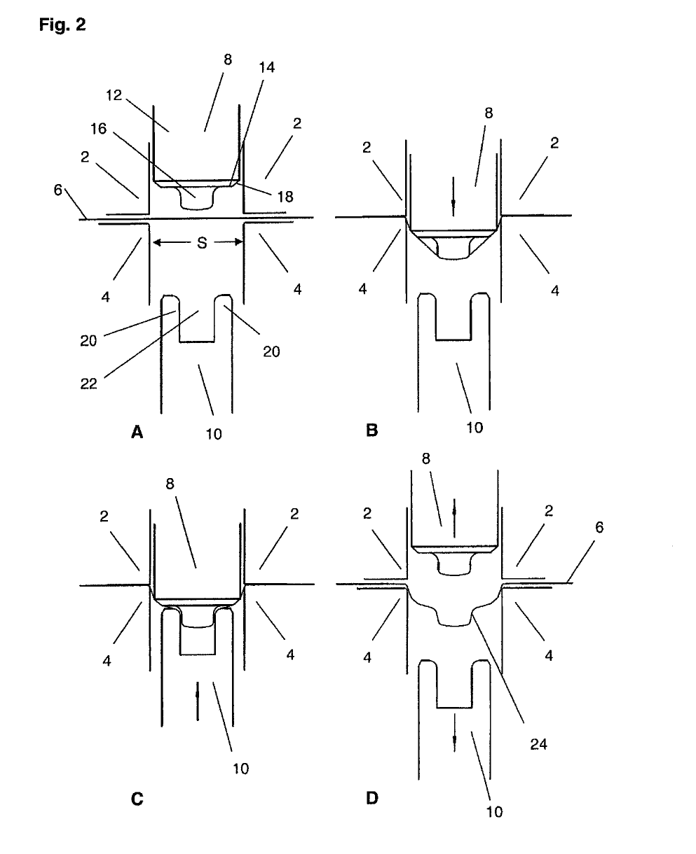

FIG. 1 shows a cross section of a first embodiment of the forming device according to the invention. Because of the symmetric design of the forming device, there is no need for a second cross-sectional view perpendicular to the first cross-sectional view.

The first embodiment of the forming device illustrated here is suitable for forming round, flat pockets for medical or pharmaceutical products, especially tablets, capsules, etc. The forming device comprises a hold-down 2 and a die plate 4, at least one of which can be moved relative to the other. Normally, only the hold-down 2 is moved toward the die plate 4 to clamp the sheet 6 to be formed between the hold-down 2 and the die plate 4. Alternatively, only the die plate 4 is moved toward the hold-down 2, or both elements are moved relative to each other. A stretching zone S of the forming device, in which the forming of the sheet 6 takes place, is created in the free intermediate space between the two sections of the sheet firmly clamped between the hold-down 2 and the die plate 4.

A stamp 8 and a counter-stamp 10, which serve to form at least one pocket in the firmly clamped sheet 6, are arranged in the stretching zone S. At least one of the two stamps, i.e., either the stamp 8 or the counter-stamp 10, can be moved relative to the other into a closed forming position of the forming device, as shown in FIG. 1C.

The stamp 8 comprises a base body 12 with a working surface 14. In the exemplary embodiment shown here, the working surface 14 is substantially horizontal, but it can also comprise slanted sections, and it always faces the counter-stamp 10. A projection 16 extending toward the counter-stamp 10 is arranged on the working surface 14; this projection is located substantially in the center of the stretching zone S. The base body 12 comprises a rounded or beveled edge area 18 at the edges of the working surface 14.

The counter-stamp 10 comprises at least one recess 22 surrounded by webs 20. The projection 16 of the stamp 8 fits into this recess as in FIG. 1C when the forming device is in the closed forming position. In the embodiment shown here, the recess is substantially as wide as the projection 16, so that the projection 16 is just able to enter the recess 22. Greater distances between the inside wall of the recess 22 and the lateral wall of the projection 16 are also conceivable, however, depending on the application in question, e.g., depending on the desired shape of the pocket and on the coefficients of friction of the projection 16 and of the sheet 6.

The course of the cold-forming process for producing a pocket in the sheet by means of the forming device according to the invention will now be described on the basis of FIG. 1. In FIG. 1A, the hold-down 2 and the die plate 4 are positioned a certain distance apart. The stamp 8 and the counter-stamp 10 are also a certain distance apart, so that the sheet 6 can be transported unhindered from a transport device (not shown) to the desired forming position.

In FIG. 1B, the sheet 6 has already been firmly clamped between the hold-down 2 and the die plate 4, and the stamp 8 has been moved down into a prestretching position. This prestretching position is the same as the position which the stamp 8 occupies when the forming device is in the closed forming position shown in FIG. 1C. In this position, the edge area 18 of the working surface 14 of the stamp 8 is located below the horizontal plane defined by the sheet 6 in FIG. 1A and therefore serves to draw the sheet taut and stretch it in the area next to that where the hold-down 2 and the die plate 4 are clamping the sheet. The distance between the stamp 8 and the hold-down 2 or the die plate 4 can vary, depending on the application, but it is usually very short.

In the closed forming position of the forming device, therefore, the sheet 6 rests both against the edge area 18 of the working surface 14 of the stamp 8 and against the projection 16 of the stamp 18. According to FIG. 1B, therefore, a section of the sheet 6 between the projection 16 and the edge area 18 of the working surface 14 of the stamp 8 is drawn taut; the webs 20 of the counter-stamp 10 also exert a forming action on this section when they move toward the closed forming position of the forming device (see FIG. 1C). In the closed forming position of the forming device, the webs 20 of the counter-stamp 10 thus lie against the sheet 6 in the intermediate area between the edge area 18 of the working surface 14 of the stamp 8 and the projection 16 of the stamp 8. In this way, in a two-stage process, a step-like geometry of the pocket 24 is created, as shown in FIG. 1D. A pocket 24 can thus be cold-formed in the sheet 6 in a well-defined, uniform manner which does not damage the material.

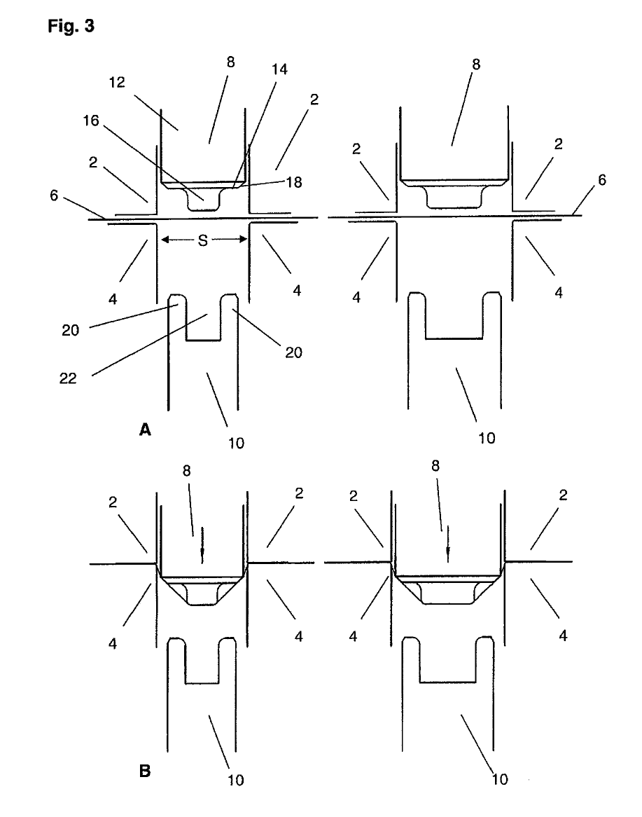

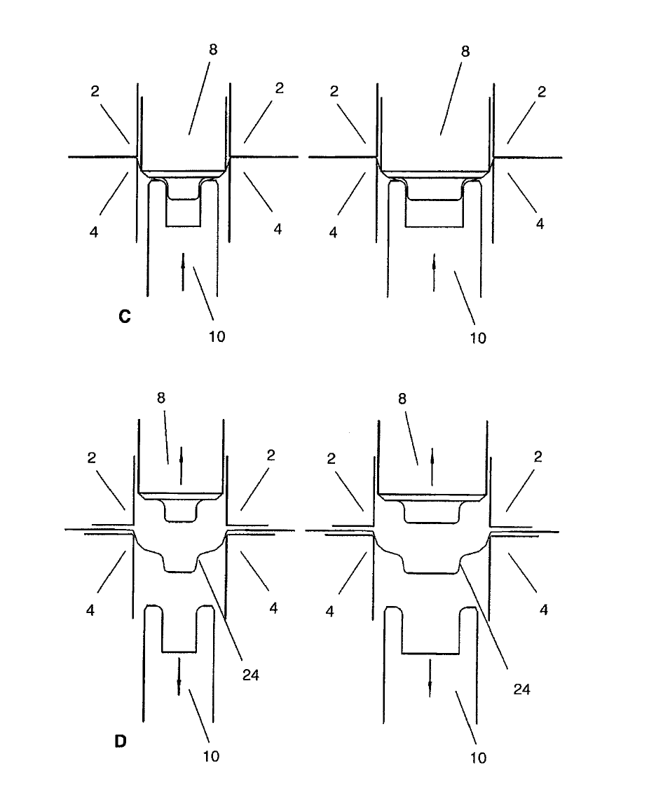

The second embodiment of the forming device according to the invention, shown in FIG. 2, is suitable for the forming of round, convex pockets. The only difference between this embodiment and the one according to FIG. 1 is the convex shape of the bottom surface of the projection 16.

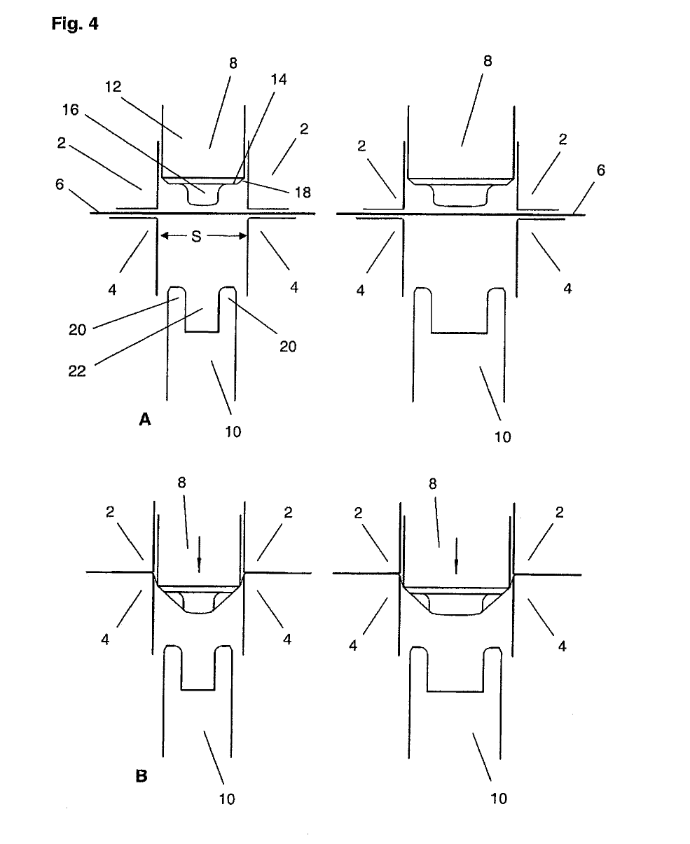

The third embodiment of the forming device according to the invention, shown in FIG. 3, is especially suitable for pockets which are intended to hold flat, oval products. It can be seen from the two adjacent cross-sectional views, the direction of one being perpendicular to that of the other, that the pockets 24 are larger in the second direction than in the first direction. Otherwise, the principle of the cold-forming process described on the basis of FIGS. 1 and 2 is the same.

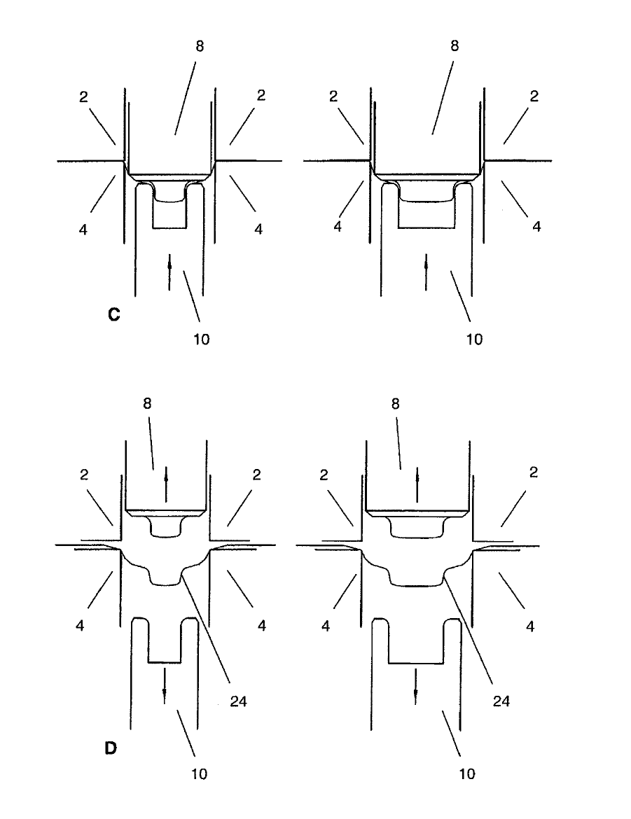

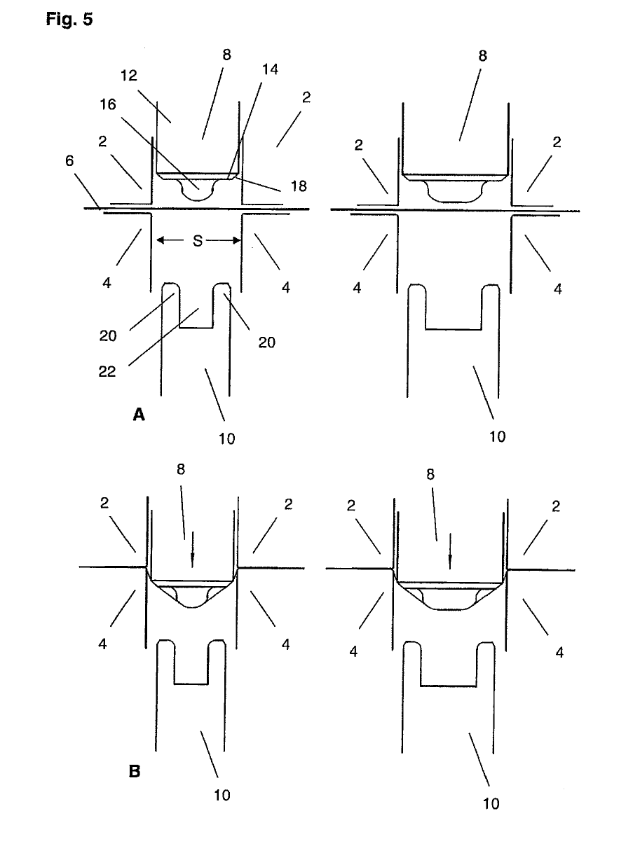

FIG. 4 shows a fourth embodiment of the forming device according to the invention, which is especially suitable for forming pockets intended to hold elongated, convex products. The difference between this embodiment and that according to FIG. 3 is to be found in the convex shape of the bottom surface of the projection 16. The various views and the way in which the forming device works are the same as those of the embodiment according to FIG. 3.

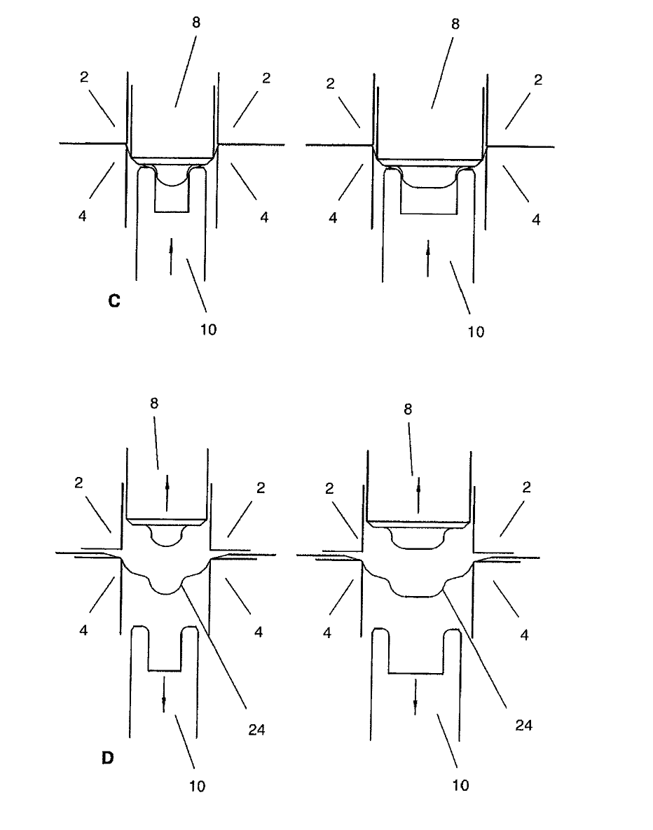

FIG. 5 shows a fifth embodiment of the forming device according to the invention, which is suitable for the cold-forming of pockets intended to hold capsule-shaped products. The various views and the way in which the forming device works are the same as those of the embodiments according to FIGS. 3 and 4. It can be seen, however, that the projection 16 is more pronounced.

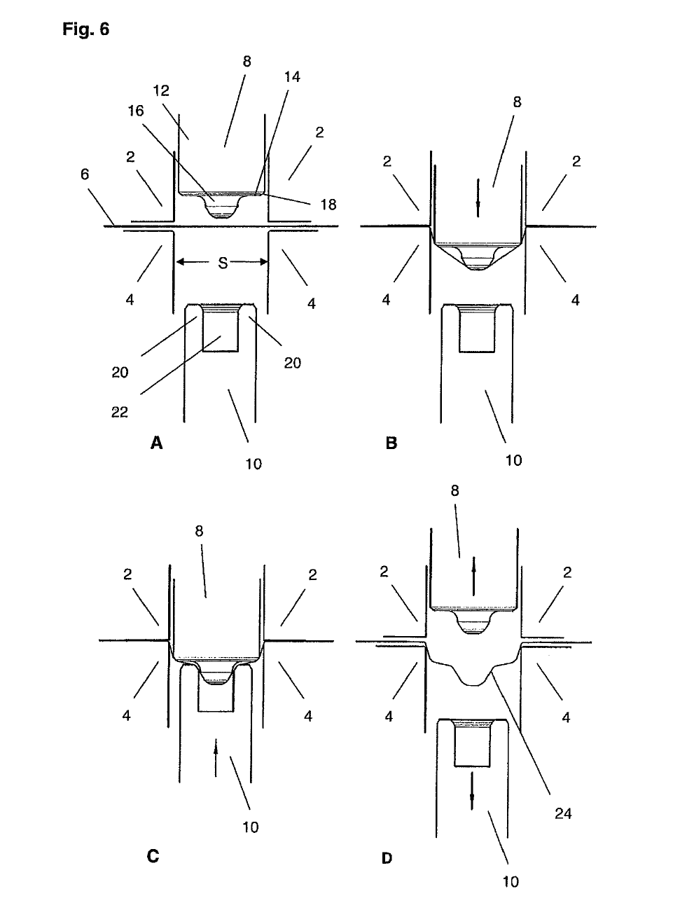

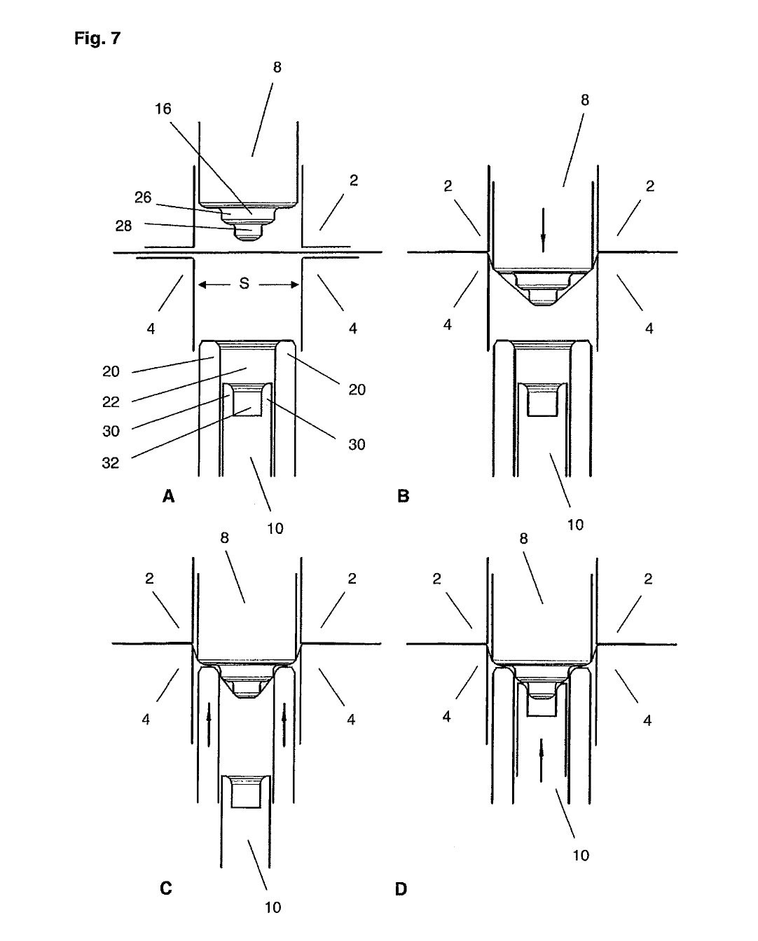

The sixth embodiment of the forming device according to the invention, shown in FIG. 6, is again suitable for the cold-forming of pockets for round, flat products (see FIG. 1). Here, however, the rounded or beveled edge area 18 of the working surface 14 of the stamp 8 comprises several steps, which are drawn in thin line. The projection 16, furthermore, is rounded or beveled at its edges and comprises several steps there also. Finally, the webs 20 of the counter-stamp 10 around the recess 22 are rounded or beveled toward the inside and comprise several inward-facing steps.

Each of the various roundings or bevelings of the above-cited components can be present individually or used in combination with each other. The steps in the various elements can also be formed only in one of the individual elements or in several of them. The term “steps” is used here to mean any form of gradual change in the outside diameter or angle of inclination or even in the surface finish of the elements in question. As a result of these steps, a graduated, more finely calibrated stretching of the sheet 6 is achieved without subjecting the material to excessive stress. This can be important for the sake of obtaining a uniform material thickness and for the reliable functioning of the forming device.

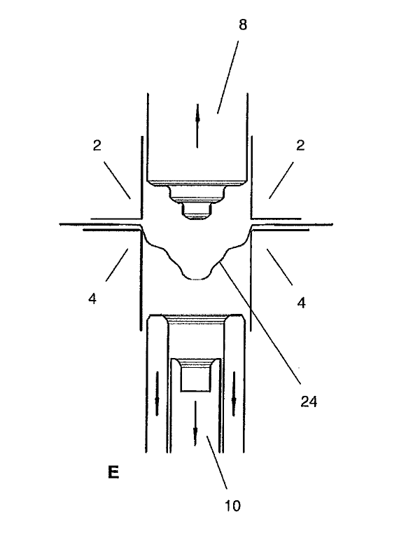

FIG. 7 shows a seventh embodiment of the forming device according to the invention. The projection 16 of the stamp 8 is designed as a two-stage element with a wide base 26 and narrower tip 28. Accordingly, the counter-stamp 10 also has a two-part design, wherein the webs 20 of the outer part of the counter-stamp 10 act on the section of the sheet located between the edge area 18 of the working surface 14 of the stamp 8 and the edge area of the base 26 of the projection 16, whereas the inner webs 30 of the inner part of the counter-stamp 10 act on the section of the sheet which extends between the edge area of the base 26 and the tip 28 of the projection 16. As a result, a forming method with more than two stages is provided. The inner and outer parts of the counter-stamp 10 can in this case be driven either in common or separately from each other. Steps can also be formed again on the various edge areas of the elements. Different details of the various embodiments can be combined.

As a general rule, the illustrated dimensions of the individual elements and their relationship to each other can vary from one application to another. In particular, the materials and coefficients of friction of the sheet 6, the stamp 8, and the counter-stamp 10 as well as the form and contour of the products to be packaged are to be taken into account. The products which can be packaged include not only the previously mentioned tablets and capsules but also ampules or any other medical of pharmaceutical objects and even industrial items. Stiffening pleats can also be formed in the sheet by this method.

Especially aluminum, steel, or hard plastics can be used as material for the hold-down 2 and the die plate 4. The stamp 8 and the counter-stamp 10 will normally be made of high-grade steel, coated aluminum, or special hard plastics. The formed pockets 24 usually have a depth of 2-50 mm. The sheets 6 to be formed by this method are usually aluminum foils or laminates of polyamide/aluminum/PVC. Polyethylene sheets, polypropylene sheets, and any possible combinations of the previously mentioned materials can also be used.

According to the description of the embodiments given above, the stamp 8 is lowered first, and then the counter-stamp 10 makes the opposing movement. It is also possible for the counter-stamp 10 to be located in its stationary end position even before the stamp 8 is lowered, as shown by way of example in FIG. 1C, and for the stamp 8, through its downward movement, to perform all the work necessary to complete the forming of the stepped pocket 24.

Any suitable mechanical, pneumatic, or hydraulic drives can be used to drive the hold-down 2, the die plate 4, the stamp 8, and the counter-stamp 10. The counter-stamp 10 can be stationary; it can move together with the die plate 4; or it can have its own separate drive.

In the examples shown here, only one pair of stamps, i.e., a stamp 8 and a counter-stamp 10, is shown in each case. In reality, several pairs of stamps 8 and counter-stamps 10 will often be arranged parallel to each other to form blister packs with several pockets 24. Only one projection 16 is arranged on each stamp 8 in the exemplary embodiments shown, but it is also possible to provide the stamp 8 with several of these projections 16.

1. A forming device for the cold-forming of pockets for medical or pharmaceutical products in a sheet, comprising:
a hold-down and a die plate, at least one of which movable relative to the other to clamp the sheet between the hold-down and the die plate in an area around at least one stretching zone of the forming device;
at least one stamp and at least one counter-stamp, which are arranged in the stretching zone and serve to form at least one pocket in the firmly clamped sheet, wherein at least one of the stamp or the counter-stamp is movable relative to the other into a closed forming position of the forming device;
wherein the stamp comprises a base body with a working surface, wherein at least one projection extending toward the counter-stamp is arranged on the working surface substantially in a center of the stretching zone, wherein the base body comprises an edge area at edges of the working surface;
wherein, when the forming device is in the closed forming position, the sheet rests both against the edge area of the working surface of the stamp and against the projection of the stamp;
wherein the counter-stamp comprises at least one recess surrounded by webs, in which the at least one projection of the stamp fits when the forming device is in the closed forming position, as a result of which the webs of the counter-stamp, when the forming device is in the closed forming position, rest against the sheet in an intermediate area between the edge area of the working surface of the stamp and the projection of the stamp;
wherein the edge area at the edges of the working surface of the base body of the stamp is rounded or beveled;
wherein the projection is rounded or beveled at its edges; and
wherein the webs around the recess are rounded or beveled toward the inside.

2. The forming device according to claim 1, wherein the rounded or beveled edge area of the working surface of the stamp comprises several steps.

3. The forming device according to claim 1, wherein the projection comprises several steps at its edges.

4. The forming device according to claim 1, wherein the webs around the recess comprise several inward-facing steps.

5. The forming device according to claim 1, wherein both the stamp and the counter-stamp are movable relative to each other.

6. The forming device according to claim 5, wherein the stamp is movable into a prestretching position first, and then the counter-stamp is movable in an opposite direction to form the closed forming position of the forming device.
